(19) United States
(12) Patent Application Publication
(10) Pub. No.: US 2023/0107269 A1
(43) Pub. Date: Apr. 6, 2023

(54) RECOMMENDER SYSTEM USING EDGE COMPUTING PLATFORM FOR VOICE PROCESSING

(71) Applicant: PONG YUEN HOLDINGS LIMITED, Hong Kong (HK)

(72) Inventor: Shun Yin CHAU, Hong Kong (HK)

(21) Appl. No.: 17/492,787

(22) Filed: Oct. 4, 2021

(51) Int. Cl. G06Q 30/06; G10L 15/30; G10L 15/26

(52) U.S. Cl. CPC G06Q 30/0631; G10L 15/30; G10L 15/26

(57) ABSTRACT

A recommender system using an edge computing platform to process concurrently multiple continuous audio streams of conversations from customers in a business establishment, and provide real-time recommendations instantly and on-the-fly in the business establishment including multiple microphone devices installed in the business establishment for simultaneously collecting and recording multiple continuous audio streams of conversations from customers in the business establishment; an edge device machine for providing recommendations after processing the recordings of the multiple continuous audio streams that are collected simultaneously, and generating texts from the collected recordings; a monitor screen connected to the edge device machine for printing and monitoring the generated texts; and digital screens installed in the business establishment for showing recommendations to the customers related to the customers' conversations. In the first phase, a voice dictation is performed, mining techniques are applied, and phrases are extracted. In the second phase, recommendations are provided to the customers.

### FIELD OF THE DISCLOSURE

The present disclosure relates in general to the field of human speech or voice processing through Deep Learning (DL) and Artificial Intelligence (AI), and more specifically to a recommender system using an edge computing platform to process human speech or voice.

### BACKGROUND OF THE DISCLOSURE

Conventionally, voice processing relates to phone recordings and transcripts, recording of meetings and conferences, speaker recognition, automatic reply to phone calls, and/or automatic conversations (human-machine or machine-machine chat). Other voice processing related fields may include (1) translation, such as bilingual translation, multilingual translation, and automatic translation, (2) electronic device activation via voice, (3) user authentication and transactions via voice processing, such as human authentication through voice, transactions through voice, order placement through voice commands via phones, (4) models and systems for personnel assessment, product/services evaluation, customer feedback, questionnaires, and/or surveys (machines-humans), and (5) product recommendations.

There is currently a need, in the context of commercial retail stores, restaurants, and other business establishment venue for which customers aim to purchase products or services, for a system or method that provides customers with useful recommendations while protecting privacy of the customers, helping owners to monitor preferences, feedbacks or complaints of the customers, and/or performing personnel assessments.

In the past, various conventional ways in field of voice processing have been disclosed. For instance, U.S. Patent Publication No. 2021/0134279 (the '279 Publication), which is titled “MACHINE LEARNING BASED PRODUCT SOLUTION RECOMMENDATION”, filed on Nov. 6, 2019 and published on May 6, 2021, requires a customer to use a device such as telephone and login to an application. In view of the '279 Publication, there is a need to process a stream of audio input and human voices, captured by multiple sources simultaneously (i.e., multiple microphones), installed in an open area (i.e., retail store or shop) without requiring use of any device such as telephone or login to any application, and a further need to use the edge computing framework by conducting the processing on an edge device machine that is installed and performed inside a retail store or shop.

U.S. Patent Publication No. 2019/0279273 (the '273 Publication), which is titled “SHOPPING RECOMMENDATION METHOD, CLIENT, AND SERVER”, filed on Oct. 15, 2018 and published on Sep. 12, 2019, relates to a voice collection device in a client-server model that collects human conversations. In view of the '273 Publication, there is a need to install microphones within the entire store, without requiring the customers to use any particular device to collect conversations, which can prevent the collection of casual and spontaneous conversations. There is a further need to use technology relating to the edge computing framework to reduce network traffic in communication. Further still, by installing an edge device machine within a store, data passing through internet network to a server, supercomputer or cloud server for further saving or processing thereof can be avoided, thereby ensuring that customers' privacy in terms of sensitive personal data such as voice and preferences can be protected.

U.S. Patent Publication No. 2010/0023410 (the '410 Publication), which is titled “METHOD AND SYSTEM FOR ENTERING ORDERS OF CUSTOMERS”, which is filed on Oct. 1, 2009 and published on Jan. 28, 2010, is related to placement of orders, and requires each customer to use a device to capture his/her voice. In view of the '410 Publication, there is a need to provide recommendations to customers inside a store, and collect customers' voices simultaneously without using any device.

U.S. Patent Publication No. 2019/0026676 (the '676 Publication), which is titled “SYSTEM AND METHOD FOR PROVIDING DYNAMIC RECOMMENDATIONS BASED ON INTERACTIONS IN RETAIL STORES”, filed on Sep. 4, 2018 and published on Jan. 24, 2019, provides analytics and requires a conversation to occur between a customer and store representative, and data transferred to another server. In view of the '676 Publication, there is a need to provide an in-store product recommendation to customers based on their casual, friendly and/or spontaneous conversations, without encountering the pressure from the store staff or the transferring of data to another server.

U.S. Patent Publication No. 2020/0019612 (the '612 Publication), which is titled “TOPIC KERNELIZATION FOR REAL-TIME CONVERSATION DATA”, filed on Sep. 23, 2019 and published on Jan. 16, 2020, focuses on topic detection through text processing. In view of the '612 Publication, there is a need to capture speech conversation from a detailed framework that includes collecting data from multiple audio/voice sources and providing recommendations to customers.

U.S. Patent Publication No. 2021/0152919 (the '919 Publication), which is titled “MICROPHONE NATURAL SPEECH CAPTURE VOICE DICTATION SYSTEM AND METHOD”, filed on Jan. 27, 2021 and published on May 20, 2021, is related to converting a voice audio stream into text. In view of the '919 Publication, there is a need to provide recommendations inside a retail store or any business establishment venue where customers aim to purchase products or services therefrom through the use of framework in edge computing technology.

U.S. Patent Publication No. 2011/0191106 (the '106 Publication), which is titled “WORD RECOGNITION SYSTEM AND METHOD FOR CUSTOMER AND EMPLOYEE ASSESSMENT”, filed on Apr. 12, 2011 and published on Aug. 4, 2011, is directed to identifying user emotions and tone of voice. In view of the '106 Publication, there is a need to offer recommendation by matching customers words with products and brands, irrespective of customers' acceptance or dissatisfaction, and without requiring a phone call or use of a device.

U.S. Patent Publication No. 2005/0216358 (the '358 Publication), which is titled “METHOD AND SYSTEM FOR EVALUATION SHOPPING”, filed on May 6, 2005 and published on Sep. 29, 2005, is directed to providing customer service evaluations to entities that seek testing of their employee's customer service skills. In view of the '358 Publication, there is a need to introduce a spontaneous way of customers giving feedback on products or services of shop assistants or employees.

U.S. Patent Publication No. 2020/0043500 (the '500 Publication), which is titled “SYSTEM AND METHOD OF PROVIDING CUSTOMIZED CONTENT BY USING SOUND”, filed on May 29, 2019 and published on Feb. 6, 2020, requires customers to use their mobile devices to collect their voices. In view of the '500 Publication, there is a need for a voice processing system in a retail store, restaurants, or any similar business establishment venue where customers aim to purchase products or services therefrom without requiring use of mobile devices to collect voices or authentication of customers through their voices.

U.S. Patent Publication No. 2019/0237081 (the '081 Publication), which is title “CONVERSATION PRINT SYSTEM AND METHOD”, filed on Jul. 18, 2018 and published on Aug. 1, 2019, focuses on identifying fraudster conversation through voice processing. In view of the '081 Publication, there is a need for a voice processing system that achieves a different goal.

### SUMMARY OF THE DISCLOSURE

It is therefore an object of the present disclosure to provide recommender system that can present product recommendations through a framework that process human voice streaming for use by stores, shops or businesses (e.g., convenience stores, restaurants, or other similar business establishment venues that allow customers to purchase product or services therefrom), and more specifically by capturing conversations of customers from within the establishment of each business, detecting related words and phrases, and providing such information to the businesses.

For instance, the captured words and phrases will be related to stores and the way the stores are operated. First, words and phrases that are related to products, brands and services that the customers wish to either purchase or not purchase can be captured since customers generally express their preference on the like or dislike of certain products that they have purchased in the past to their friends. Second, words or phrases that provide certain information on the ways the stores are operated can be captured since customers generally talk with their friends by expressing openly their satisfaction or dissatisfaction with respect to prices, offered discounts and packages, shop assistants, and/or other employers. Indeed, customers are more likely to provide comments, feedback and complaints while talking with their friends. Such real time feedback is an asset in helping the stores to improve their business operations.

It is a further object to use edge computing framework, install microphones within the stores for recording conversations of the customers, and provide edge device machines to the stores. The recorded conversations are collected and then processed to provide suitable and appropriate recommendations. Specifically, deep learning models for speech processing are pre-installed in the edge device machines.

In order to achieve the above-mentioned objects, the present disclosure performs voice processing in two phases. In the first phase, a voice dictation is performed, whereby human speech is converted to text. Next, text mining techniques are applied in order to detect and extract words and phrases that are related to the business and its products and services only. Finally, the extracted phrases are presented to the store owners. In the first phase, the owners can overview and evaluate customers' preferences by reading the generated text. The text mining algorithms can further process the extracted text by performing topic detection, top frequent words and phrase identification, and collection of statistics and relevant analytics.

In the second phase, recommendations are provided to the customers. These recommendations will be shown on digital screens located in the stores. The edge device in the second phase is connected to a database belonging to the stores. Using data mining techniques, text words and phrases that were generated in the first phase are matched with the items that are stored in the database which is located within the stores. Generally, the different database designs would mean that the elements of the database can be assigned to tags in different ways and yet related products or brands can be assigned to the same tag. The present disclosure utilizes database design functionalities in order to relate the words and phrases with the elements that are stored in the database. As a result, the present disclosure allows for locating similar products, services, brands, and discounts with the discussed conversations by the customers.

To start, the present disclosure allows recording of audio streaming human-voice through microphones that are installed inside retail stores, restaurants or any establishment venue where customers aim at purchasing products or services, and has a processing framework that processes concurrently multiple continuous audio streams of human speech/voices simultaneously. The present disclosure then provides real-time recommendations instantly and on-the-fly. Specifically, customers' conversations are collected from within the store in order to detect words and phrases that are related to store products, services and phrases that are considered as customer preferences, feedback or complaints. Recommendation of related products to customers' conversations are returned and shown back to the customers via digital screens that are installed inside the store. The disclosure further utilizes technology relating to the edge computing framework for storing and handling all required processing.

Amongst the many functionalities, the edge machine processes multiple continuous streams of human voices that are collected from inside the store pertaining to, e.g., speech audio streams, using deep learning models for speech recognition. Also, the edge machine provides recommendations to customers inside the store by applying cutting edge recommendation algorithms and models.

The present disclosure is useful to both customers and store owners. On one hand, customers are able to find deals on products that they talk about with their friends, instantly, and get recommendations on brands, products, discounts, while they are browsing around the store. On the other hand, store owners are able to review customer feedback and complaints on products and services, and perform personnel assessment when comments are related with staff and shop assistants. Since different groups of customers will have different conversations, the present disclosure is customer adaptive by providing different recommendations for different groups.

In conclusion, present disclosure indicates a novel shopping model. It offers a new, dynamic, adaptive shopping experience to customers where they will be able to be informed about products and services while they are browsing around the store and discuss casually with their friends, without feeling the pressure of a shop assistant next to them. Additionally, the disclosure suggests a novel evaluation and assessment model for businesses by helping store owners to collect customer preferences, feedback and complaints and perform personnel assessment in a discreet way. Specifically, a new way of conducting customer surveys inside the store has been offered. Usually, people are more honest, sincere and real when they talk with their friends or with people they trust, and they will usually be reluctant to participate in a survey or answer a questionnaire conducted in traditional ways.

Further still, the present disclosure proposes a novel advertising model inside the store. Digital screens that are installed inside the store will show product recommendations and related promotion deals and advertisements that are relevant each time to the preferences of each group of customers. Last but not least, the present disclosure protects customers' privacy by not storing any recorded conversations, filtering out sensitive and irrelevant information by only extracting relevant phrases to the business products and services and not matching customers with their opinions, and not creating any user profiles since speech is processed instantly and on-the-fly.

### BRIEF DESCRIPTION OF THE DRAWINGS

Additional features and advantage of the present disclosure will be made apparent from the following detailed description of one or more exemplary embodiments with reference to the accompanying figures, which are given for illustrative purpose only, and thus are not limitative of the present disclosure, wherein:

FIG. 1 illustrates workflow steps according to the present disclosure;

FIG. 2 illustrates a location blueprint showing exemplary placements of microphones business shop according to the present disclosure;

FIG. 3 illustrates an edge machine processing recorded conversation as depicted in FIG. 2 according to the present disclosure;

FIG. 4 illustrates the connections of the edge machine to a sample database with its stored entities according to the present disclosure;

FIG. 5 illustrates another location blueprint showing exemplary placements of digital screens.

### DETAILED DESCRIPTION OF THE EXEMPLARY EMBODIMENTS

One or more exemplary embodiments according to the present disclosure directed to a recommender system using an edge computing platform to process human speech or voice will be described below with references to the accompanying figures. It should be understood that the figures are not depicted to scale.

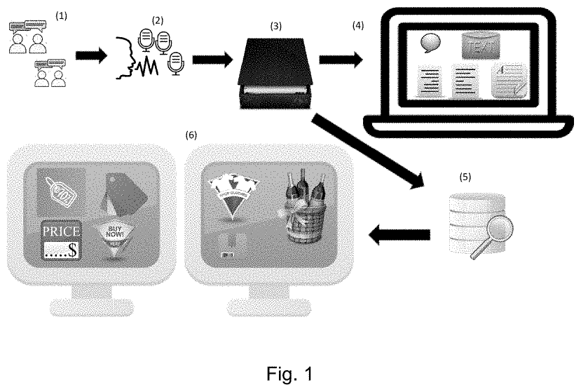

FIG. 1 illustrates a workflow of 6 steps. In step 1, customers are having casual conversation with one another at a retail store, or at any similar business establishment where customers aim to purchase products or services from the establishment. In step 2, customers' voices are recorded through microphones installed in the store vicinity.

In step 3, the edge computing technology is applied in that an edge device machine is installed in the store for processing the voices collected in step 2. Deep learning models and algorithms for voice processing are pre-installed in the edge device, and applied in this step. Specifically, the deep learning models and algorithms perform the following tasks: Automatic Speech Recognition and Natural Language Processing. In particular,

Automatic Speech Recognition receives as an input an audio, generates a script out of the human speech, and outputs the text script; whereas Natural Language Processing receives as input a text document, which is analyzed and broken down to sentences and word-tokens, i.e., document tokenization, and outputs relationships of words such as their frequency occurrences, word correlation, words frequently grouped together, topic detection, and etc. The goal is to detect and collect keywords and phrases that are relevant with the store only (useful). By using pretrained voice/speech recognition models, conversations of the customers that contain private or sensitive information are discarded, and only those words and phrases that are relevant to the particular business (useful) are kept.

In step 4, the edge device machine performs the task of Voice Dictation by printing the generated text from the useful keywords and phrases that were extracted and gathered in the previous step. A software with a Graphical User Interface (GUI) is pre-installed on the edge device for this purpose. This information is shown on a monitor installed in the store owner's office.

In step 5, the edge device machine of step 3 searches in a business database to find products, brands, type of products, discounts that are related to the words that customers have used in step 1, and subsequently recorded in step 2 and extracted in step 4. In this step, the product matching, which is part of the Recommender Systems, is performed. The Recommender System is also pre-installed in the edge device. Specifically, the recommender system consists of models and algorithms that perform the following tasks: receiving as input the user preferences (which are the useful keywords that were extracted in step 3), and the items (which are the keywords of the products and services that are stored in the database with the keywords of their names, description, descriptive tags, attributes, properties); the two are then matched (user preferences with items) by converting words to vectors and by finding similarity probabilities between these vectors, and ranked accordingly; and finally the top similar candidates, which is the top similar items to user preferences, are returned as output. In step 6, product recommendations are presented to customers through large digital screens that are installed in various locations in the store. In other words, the most similar product items to user preferences of step 5 are shown to customers through the screens.

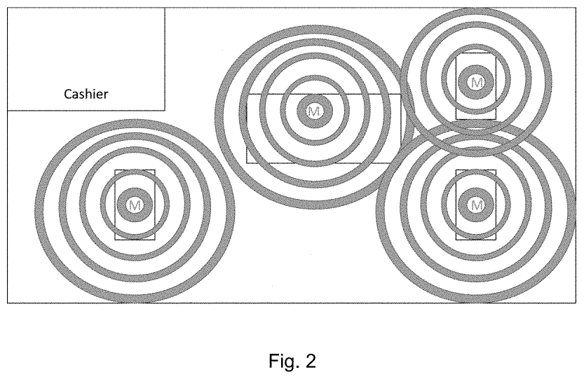

Referring to FIGS. 1 and 2, when customers enter the store, they tend to casually talk with their friends regarding their preferences, likes or dislikes on the types of clothes, various brands, and different types of fabrics. They would in particular chat on the various kinds of clothes they would like to purchase, preferred brands, or the amount of money they are willing to spend.

Such useful information is captured by the present disclosure.

More specifically, when customers talk with each other among friends, they freely express in a casual way and generally feel comfortable. Thus, they tend to be honest, sincere, and real without attempting to hide or hold back. This type of conversation can help the store owner to evaluate a specific store of interest to the store owner. For instance, information can be extracted pertaining to the specific store on its products, prices, discounts and packages. Also, at times customers may express their satisfaction or even annoyance on staff, shop assistants and/or other employees who work at the store. Indeed, without interruptions from a shop assistant, people tend to talk in a more casual way with friends, and express their opinion or dissatisfaction more spontaneously. The present disclosure captures customers' conversations using microphones that are installed in various visible places in the store, as illustrated in FIG. 2, by converting human voices into audio streams.

FIG. 2 illustrates an exemplary blueprint for a retail store that installs microphones at indicated locations in the store. The range that the microphones cover in the store should be as wide as possible. In particular, microphones should be placed in visible locations among products, on counters or other locations inside the store.

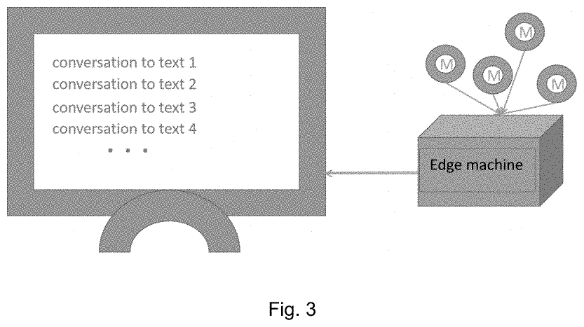

After the microphones are installed, conversations are collected for processing by an edge device machine that is provided within the store as shown in FIG. 3. The present disclosure applies the technology from the edge computing framework. Human speech will be processed by deep learning models and algorithms for voice processing. These models are pre-installed and run on the edge device machine. Specifically, the deep learning models and algorithms perform tasks similar to Automatic Speech Recognition, Natural Language Processing and Voice Dictation. As described above, these models process the recorded voice recordings to text, and determine correlations between words and phrases. These models also discard private or sensitive information that customers may have discussed and words and phrases that are irrelevant to the kind of products that the store is selling. The words and phrases that are finally kept through filtering are shown in a text format on a monitor connected to the edge device and located, e.g., inside the office of the store owner.

Specifically, the edge device machine that processes the recorded conversations from FIG. 2 is shown in FIG. 3, along with a presentation of the output text on the monitor. The edge machine device performs voice dictation by processing the recorded voices using the pre-installed deep learning models for speech recognition. The models detect only words and phrases that are relevant to the products and the services that the particular store is selling or offering. Irrelevant or sensitive information that customers may have discussed is discarded, with the words and phrases that are finally kept, after the filtering, shown at the monitor connected to the edge machine device. At this stage, the store owner can review customers' feedback, reviews, complaints on products, services, prices, and etc. Additionally, the store owner can perform personnel assessment by reading the comments that customers make regarding staff and/or shop assistants.

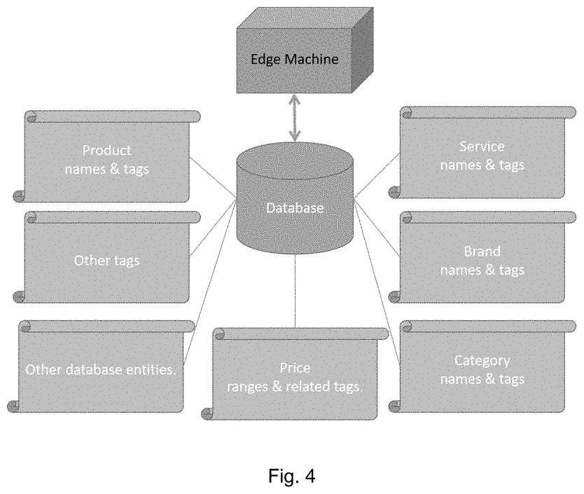

FIG. 4 shows the edge device being connected to the store database that contains products, service names and tags, brand names and category names and tags, price ranges and related tags, product names, attributes, properties and tags, other tags, and other database entities. The edge device can access the database for the products, brands, services, categories, and their corresponding tags. Thereafter, the words of the customers that are kept after the filtering, as shown in FIG. 3, are matched with these accessed elements, thereby locating similar products and services and hence, resulting in recommendations.

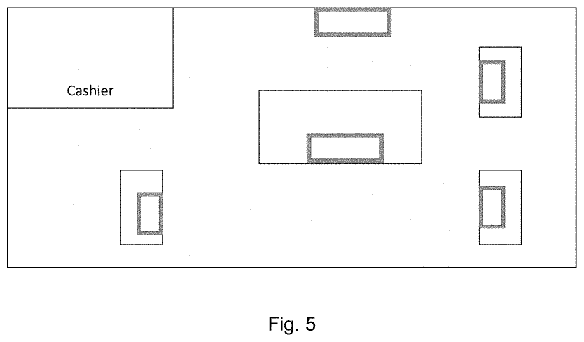

FIG. 5 is a location blueprint showing exemplary placements of digital screens in the store. Specifically, multiple digital screens are placed in various locations within the store in order to present recommendations to customers so that customers can view the recommendations that include promoted products, brands and packages.

Turning to the two phases involved in the voice processing, the information collected in the first phase is very useful to the store owners. Specifically, the store owners may perform evaluation of the conversations of the customers. The store owners may also detect product names, brands, price ranges and other preferences that may have been discussed by the customers. Indeed, any feedback or complaints that the customers made regarding the store, shop assistants or any other issue related to the store can be made aware to the store owners so that store owners can conduct an assessment evaluation at this stage.

In the second phase, recommendations are provided back to the customers, as shown in FIGS. 1 and 5. The edge machine processes the text that was generated earlier. Text mining algorithms are applied to detect the most frequent words related to clothing industry as well as the discussed topics in the conversations. Thereafter, the edge machine searches within the store database, as shown in FIG. 4, for any similar items, such as products, brands, discounts that are related with the conversations of the customers. Matching of similar keywords between the converted text from voice and the elements stored in the database are detected. At the end, similar products, brands and offers are shown to the customers on large digital screens that are placed in various locations inside the store, as shown in FIGS. 1 and 5.

For an example, if two friends enter the store and discuss buying a suit, then after a few seconds, they will be able to see on the digital screens that exist inside the store discounts with suits and brands that the store offers with their prices. Perhaps the recommendation further shows them shirts and shoes that match with each suit.

In another exemplary embodiment, the present disclosure is utilized in the restaurant industry. For instance, while people are deciding what to order, they discuss what dishes and beverages they would like to taste or try. Because they are talking among friends, they make comments on the menu casually and more spontaneously. They talk about the dishes, whether they have tasted them in the past and whether they liked them or not.

Similar to the exemplary embodiment regarding the store, the restaurant owners can collect customer feedback in the in the first phase, and use such as an evaluation of their own restaurants through, e.g., real-time reviews on dishes and beverages. In the second phase, recommendations of the matched sides and dishes can be recommended to the customers through digital screens that are placed in the restaurant. As an example, if friends take a table in a restaurant, and talk about having a steak, they can see a set with roasted steak with french fries included, and maybe a bottle of wine that tastes good with this dish.

Both customers and store owners can benefit from the recommender system using the edge computing platform, which can include an edge computing framework, for voice processing as provided by the present disclosure. For instance, just by discussing with their friends, customers are able to get instantly and on-the-fly recommendations and information on similar products, brands and related discounts. Also, owners of business shops can promote specific products that customers are interested in. By introducing a customer-adaptive shopping model, meaning different group of customers can discuss different preferences at different times during the day, and yet proper and suitable recommendations are offered each time through adaption in the present disclosure.

In short, a number of innovative features have been set forth in the present disclosure. Firstly, a novel customer-adaptive shopping model offers a new, dynamic, adaptive shopping model to customers where they can be informed about products and services while they are browsing around the business shops and discuss casually with their friends, without feeling the pressure of the existence of a shop assistant who judges them.

Moreover, the disclosure suggests a novel evaluation and assessment model for businesses by helping store owners to collect customer preferences, feedback and complaints and perform personnel assessment in a discreet way. Specifically, a new way of conducting customer surveys inside the store has been offered. Usually, people are more honest, sincere and real when they talk with their friends or with people they trust. On the other hand, people are usually reluctant to participate in a survey or answer a questionnaire that is conducted in traditional methods as answering to questions to a shop assistant, or filling a paper-questionnaire. In the first case, they feel the pressure of the shop assistant who is standing next to them, whereas in the second case, the questions may not be relevant with what the customers want to report.

Furthermore, the present disclosure proposes a novel advertising model inside the store. Digital screens that are installed inside the store will show product recommendations and related promotion deals and advertisements that are relevant each time to the preferences of each group of customers. Last but not least, the present disclosure protects customers' privacy by not storing any recorded conversations, filtering out sensitive and irrelevant information by only extracting relevant phrases to the business products and services and not matching customers with their opinions, and not creating any user profiles since speech is processed instantly and on-the-fly.

Although the present disclosure has been described with reference to specific embodiments, this description is not meant to be construed in a limiting sense. It should be understood that the scope of the present disclosure is not limited to the above-mentioned embodiments, but is limited by the accompanying claims. It is, therefore, contemplated that the appended claims will cover all modifications that fall within the true scope of the present disclosure. Without departing from the object and spirit of the present disclosure, various modifications to the embodiments are possible, but they remain within the scope of the present disclosure, will be apparent to persons skilled in the art.

What is claimed is:

1. A recommender system using an edge computing platform to perform voice processing of multiple continuous audio streams from conversations between customers in a business establishment, and provide real-time recommendations in the business establishment, comprising:
one or more microphone devices installed in the business establishment for simultaneously collecting and recording multiple continuous audio streams of conversations from customers in the business establishment;
an edge device machine for providing recommendations after processing the recordings of the multiple continuous audio streams that are collected simultaneously, and generating texts from the collected recordings;
a screen monitor connected to the edge device machine for printing and monitoring the generated texts; and
one or more digital screens installed in the business establishment for showing recommendations to the customers related to the conversations of the customers.

2. The recommender system of claim 1, wherein the microphone devices cover all areas of the business establishment.

3. The recommender system of claim 1, wherein the voice processing of the recorded audio streams from microphones includes converting the recorded audio streams into text messages, and printing the converted text messages through the screen monitor which is connected to the edge device machine.

4. The recommender system of claim 1, wherein the digital screens in the business establishment instantly, on-the-fly and on real-time show relevant recommendations to the customers regarding products, brands, services, discount-offers, packages, or any similar and related information pertaining to customers' conversations.

5. The recommender system of claim 1, wherein an edge computing framework is used in the edge computing platform.

6. The recommender system of claim 1, wherein the collecting and recording of multiple continuous audio streams include conversations between customers and discussions between an employee of the business establishment and the customers.

7. The recommender system of claim 3, wherein the voice processing of the recorded audio streams from microphones further includes applying deep learning, speech recognition, and machine learning models, performing voice dictation by converting speech to text, filtering out sensitive information or phrases that are irrelevant to the business establishment, and printing the filtered text to a monitor connected to the edge device machine for an owner of the business establishment to review.

8. The recommender system of claim 7, wherein the owner of the business establishment performs an evaluation of the employee based on the recordings.

9. The recommender system of claim 1, wherein the generated texts from the collected recordings are further process using text-mining methods by detecting conversation topics, most frequent top-k words, or text-mining algorithms.

10. The recommender system of claim 1, further comprising a store database which includes product names, brands, product types, categories, subcategories, discounts/packages/offers, along with tags and ratings and items descriptions that relate to products and services sold to the customers.

11. The recommender system of claim 10, wherein the processing the recordings of the multiple continuous audio streams includes a deep learning for extracting information from the store database on products similar to words, phrases and topics from the generating texts.

12. The recommender system of claim 11, wherein the extracted information is provided to the customers as recommendations through the digital screens.

13. The recommender system of claim 1, wherein the edge device machine, which is preinstalled with deep learning models for audio processing, speech recognition, voice dictation, text filtering, and text mining to generate recommendations, is located inside the business establishment and not connected to a server or cloud infrastructure.

14. The recommender system of claim 1, wherein the multiple continuous audio streams of conversations from customers are casual conversations among customers that are not made to a phone or an electronic device that uses a login procedure.

15. The recommender system of claim 1, wherein sensitive details or information irrelevant to the business establishment are filtered out to protect customers' privacy, which is further enhanced by not recording conversation history and not creating any user profile that can match the recorded conversation to the customers.

16. The recommender system of claim 1, wherein different recommendations are adapted based on different groups of the consumers discussing different topics.

17. The recommender system of claim 1, wherein the multiple continuous audio streams in a form of human voices or speeches in real-time from the microphone devices are processed instantly and on-the-fly in the business establishment to provide real-time recommendations.

18. The recommender system of claim 1, wherein the customers experience an adaptive shopping model by being informed of products and services while the customers are browsing the business establishment, having casual conversations and no interfering interactions with the store employee.

19. The recommender system of claim 7, wherein the owners of the business establishment collect feedback of the customers to perform personnel assessment discreetly, and a survey of the customers in the business establishment can be conducted even without the need of providing customers questionnaires.

20. The recommender system of claim 1, wherein advertising, including promotional deals, appear at different times to different groups of the customers in the business establishment through the digital screens.
